(19) United States
(12) Patent Application Publication
(10) Pub. No.: US 2026/0259568 A1
(43) Pub. Date: Sep. 3, 2026

(54) METHOD FOR MOVING A LARGE NUMBER OF BALES

(71) Applicant: DEERE & COMPANY, MOLINE, IL (US)

(72) Inventor: BENJAMIN NEERMANN, Mannheim (DE)

(21) Appl. No.: 19/424,802

(22) Filed: Dec. 18, 2025

(30) Foreign Application Priority Data
Mar. 3, 2025 (EP) 25161306.3

(51) Int. Cl. G05D 1/648; G05D 1/667; G05D 105/15; G05D 107/20

(52) U.S. Cl. CPC G05D 1/6484; G05D 1/667; G05D 2105/15; G05D 2107/21

(57) ABSTRACT

A method for moving a plurality of bales which, during a removal operation on a harvest field, are collected via at least one collection vehicle and stored at a storage location inside or outside the harvest field, includes determining via a control unit a storage position of the storage location as a function of a plurality bale positions of the plurality of bales in the harvest field, and varying via the control unit the storage position of the storage location during the removal operation.

### CROSS-REFERENCE TO RELATED APPLICATIONS

This application claims priority to European Patent Application No. 25161306.3, filed Mar. 3, 2025, which is hereby incorporated by reference.

### FIELD OF THE DISCLOSURE

The disclosure relates to a method for moving a large number of bales.

### BACKGROUND

During baling operations, a baler travels across a field to pick up crop from the field, form bales with the crop, and then deposit the bales back onto the field. The bales are then collected from the field and stored for feeding livestock at a later time.

### SUMMARY

According to an aspect of the present disclosure, a method for moving a plurality of bales which, during a removal operation on a harvest field, are collected via at least one collection vehicle and stored at a storage location inside or outside the harvest field, includes determining via a control unit a storage position of the storage location as a function of a plurality bale positions of the plurality of bales in the harvest field, and varying via the control unit the storage position of the storage location during the removal operation.

According to an aspect of the present disclosure, the storage location includes at least one transport vehicle for the removal of the plurality of bales.

According to an aspect of the present disclosure, the storage location includes a transport fleet comprising at least two transport vehicles.

According to an aspect of the present disclosure, a position path for changing the position of the storage location is determined via the control unit for the storage location.

According to an aspect of the present disclosure, a vehicle function of the transport vehicle is controlled as a function of the position path.

According to an aspect of the present disclosure, the transport vehicle is designed to be controlled as an autonomous vehicle.

According to an aspect of the present disclosure, a bale path for approaching plurality of bales and for transporting the plurality of bales to the storage location is predetermined for the collection vehicle.

According to an aspect of the present disclosure, a work plan for collecting the plurality of bales and storing the plurality of bales at the storage location is predetermined for the collection vehicle.

According to an aspect of the present disclosure, a vehicle function of the collection vehicle is controlled as a function of the predetermined bale path and the predetermined work plan.

According to an aspect of the present disclosure, a tool function of a loading tool, which is arranged to collect and load the plurality of bales on the collection vehicle, is controlled as a function of the predetermined work plan.

According to an aspect of the present disclosure, the collection vehicle is designed to be controlled as an autonomous vehicle.

According to an aspect of the present disclosure, the position path, the bale path, and the work plan are predetermined as a function of at least one of the following parameters: at least one bale-based feature of the plurality of bales, at least one field-based feature of the harvest field, at least one vehicle-based feature of the collection vehicle, at least one tool-based feature of a loading tool of the collection vehicle, at least one vehicle-based feature of the transport vehicle, and at least one environment-based feature of the environment of the collection vehicle.

According to an aspect of the present disclosure, at least one of the parameters is represented via sensor signals from sensors arranged on the collection vehicle.

According to an aspect of the present disclosure, a system for moving a plurality of bales which, during a removal operation on a harvest field, are collected via at least one collection vehicle and stored at a storage location inside or outside the harvest field, includes a control unit configured to determine a storage position of the storage location as a function of a plurality of bale positions of the plurality of bales in the harvest field, and vary the storage position of the storage location during the removal operation.

According to an aspect of the present disclosure, the control unit is configured to determine a position path for changing the position of the storage location.

According to an aspect of the present disclosure, the control unit is configured to predetermine a bale path for approaching and transporting the plurality of bales to the storage location for the collection vehicle.

According to an aspect of the present disclosure, the control unit is configured to predetermine a work plan for collecting the plurality of bales and storing the plurality of bales at the storage location for the collection vehicle.

According to an aspect of the present disclosure, the control unit is configured to control a tool function of a loading tool, which is arranged to collect and load the plurality of bales on the collection vehicle, as a function of the predetermined work plan.

According to an aspect of the present disclosure, the control unit is configured to predetermine the position path, the bale path, and the work plan as a function of at least one of the following parameters: at least one bale-based feature of the plurality of bales, at least one field-based feature of the harvest field, at least one vehicle-based feature of the collection vehicle, at least one tool-based feature of a loading tool of the collection vehicle, at least one vehicle-based feature of the transport vehicle, and at least one environment-based feature of the environment of the collection vehicle.

According to an aspect of the present disclosure, the system includes at least one sensor arranged on the collection vehicle providing sensor signals representing at least one of the parameters.

The above and other features will become apparent from the following detailed description and accompanying drawings.

### BRIEF DESCRIPTION OF THE DRAWINGS

The method according to the disclosure will be explained in more detail below with reference to the appended drawings. Component parts of equivalent or comparable function are identified by the same designations. In the figures:

FIG. 1 shows a schematic plan view of a harvest field with bales, a collection vehicle and a storage location;

FIG. 2 shows an illustration in the manner of a block circuit diagram of a system for carrying out the method according to the disclosure in a first embodiment; and

FIG. 3 shows an illustration in the manner of a block circuit diagram of a system for carrying out the method according to the disclosure in a second embodiment.

Like reference numerals are used to indicate like elements throughout the several figures.

### DETAILED DESCRIPTION

The embodiments or implementations disclosed in the above drawings and the following detailed description are not intended to be exhaustive or to limit the present disclosure to these embodiments or implementations.

US 2019/0289769 A1 discloses a method of the generic type, in which a collection vehicle collects bales lying within a harvest field and transports them to a storage location inside or outside the harvest field, in order to load the bales there. It is attempted to keep vehicle distances of the collection vehicle within the harvest field short.

It is an object of the present disclosure to improve the efficiency during the collection and loading of the bales.

This object is achieved by a method having the features of one or more embodiments disclosed herein.

Further advantageous refinements of the method according to the disclosure can be found in one or more embodiments disclosed herein.

According to some embodiments, a method is proposed for moving a large number of bales which, during a removal operation on a harvest field, are collected by means of at least one collection vehicle and stored at a storage location inside or outside the harvest field. The storage position of the storage location is determined as a function of the bale positions of the bales located in the harvest field. In addition, the storage position of the storage location can be varied during the removal operation. In other words, the storage position can be re-determined repeatedly during the removal operation.

The removal operation can include various working sequences, for example a collection operation (i.e. the collection of the bales on the harvest field), transport of the collected bales to the storage location and a loading operation (i.e. the storage or loading of the collected bales at the storage location).

The variable determination of the storage position of the storage location can be carried out as a function of the bale positions and optionally also of further parameters. Changing the storage position can be used, for example, to optimize driving distances of the collection vehicle during the removal operation. For example, in this way driving distances of the collection vehicle to the bale positions and to the storage location can be minimized. This reduces the costs for the working sequences during the removal operation. In addition, undesired soil compaction on the harvest field is reduced.

With the variable storage position of the storage location, it is possible to react flexibly to unforeseen influences during the removal operation. Such influences can be, for example, weather conditions, failure of one or more collection vehicles or changing conditions at the storage location itself. Despite these influences, the desired efficiency of the removal operation can be maintained or even improved by the variable storage position.

The collection vehicle is for example designed as a working machine (e.g. a tractor), which can be coupled to a suitable loading tool or attachment in order to collect the bales.

The storage location, for example, includes at least one transport vehicle for the removal of the loaded bales. The mobility of the transport vehicle permits flexible changes of the storage position of the storage location in a technically simple manner. With the aid of the transport vehicle, the storage location can be moved to another position at any time during the removal operation if this other position is determined to be more efficient. With the possibility of a changed storage position, the at least one transport vehicle and the at least one collection vehicle can be coordinated intelligently with one another during the removal operation and with the effect of the most efficient possible working sequence.

For example, the storage location includes a transport fleet comprising at least two transport vehicles. The individual transport vehicles can be arranged jointly at the same storage position. Alternatively, it is possible to arrange two or more transport vehicles at different storage positions and consequently to provide a plurality of partial storage locations. Thus, intelligent coordination of the transport vehicles with the at least one collection vehicle is further supported. Because of the variability of the storage position(s), it is therefore possible optionally to generate either a common storage position of all the transport vehicles or different storage positions of a plurality of transport vehicles during the removal operation. This selection can also be changed again as needed during the removal operation. In this way, the removal operation can be carried out more flexibly and more efficiently.

For example, for the storage location or for each of the aforementioned partial storage locations, in each case a position path along which the storage location or partial storage location is moved to a new storage position during the removal operation, i.e. a movement path, is predetermined. A predetermination of such movement paths for the respective storage location supports logistically structured changes or optimizations of the storage location if these are determined as expedient during the removal operation, for example to improve the efficiency of the removal operation.

For example, a vehicle function of the transport vehicle is controlled as a function of the predetermined position path. The vehicle function of the transport vehicle is, for example, a steering function or a driving function (e.g. driving strategy, driving speed, forward/reverse travel) of the transport vehicle. The transport vehicle is controlled as a function of the predetermined position path, for example by suitable control means, which can be arranged inside and/or outside the transport vehicle.

For example, the position path is generated in a control unit (e.g., a controller including a processor and memory) arranged in the collection vehicle and communicates corresponding control data to a transmitter unit likewise arranged in the collection vehicle. This transmitter unit can communicate with a receiver unit arranged in the transport vehicle, which supplies the internal steering function or the internal driving function of the transport vehicle with the control data.

Automation of the removal operation is supported by the predetermined position path. For example, the predetermined position path can be used for a (partly) autonomously operating transport vehicle.

In another embodiment, the transport vehicle is designed as a partially or fully autonomous vehicle. Its vehicle functions can then be at least partly controlled automatically, which contributes to a higher level of automation of the removal operation. The controller can be arranged inside and/or outside the transport vehicle. For example, suitable control means which communicate with the transport vehicle are included in the collection vehicle. Alternatively, the control means can be a constituent part of a central control station positioned inside or outside the harvest field. However, in the partially or fully autonomous transport vehicle, a driver can be provided in the vehicle cab as a manual fall-back level.

Advantageously, a bale path, i.e. a route along which bales are collected and collected bales are transported to the storage location, is predetermined for the collection vehicle. Predetermining such routes for the at least one collection vehicle supports logistically efficient performance of the removal operation.

More advantageously, a work plan relating to the collection of the bales and to the storage of the collected bales at the storage location, for example loading the collected bales onto a transport vehicle, is predetermined for the collection vehicle. The work plan supports structured and time-efficient collection of the bales and storage or loading of the collected bales at the storage location.

In another embodiment, a vehicle function of the collection vehicle is controlled as a function of the predetermined bale path and/or the predetermined work plan. The vehicle function of the collection vehicle is, for example, a steering function or a driving function (e.g. driving strategy, speed, forward/reverse travel) of the collection vehicle. In this way, an automated method sequence is supported, in that the collection vehicle travels, for example automatically, to specific bales and to the storage location or to the transport vehicle. The control of the collection vehicle as a function of the predetermined bale path and/or the predetermined work plan is carried out for example by suitable control means, which can be arranged inside and/or outside the collection vehicle.

In the event of a combined application of the bale path and the work plan, both the routes of the collection vehicle to the bales and between the bales and the storage location (for example the transport vehicle), and also the collection of the bales and their storage or loading at the storage location can be automated. A change between manual operation by a driver for the collection and storage of the bales, on the one hand, and automated driving sequences of the collection vehicle, on the other hand, is then superfluous. However, in the case of this automation, the driver can be present in the collection vehicle to monitor the removal operation and as a fall-back level in the event of any technical disruptions.

For example, depending on the predetermined work plan, a tool function (e.g. movement, gripping, loading) of a loading tool (e.g. loading forks, gripping clamp, shovel) which is arranged on the collection vehicle and is used to collect and load the bales can be controlled. On the basis of the determined work plan, operating movements of the loading tool can be carried out automatically without a driver. For this purpose, for example, the data from the work plan can be transmitted to a control unit (e.g., a controller including a processor and memory) of the collection vehicle, which activates the loading tool in order to grip bales or to store or load the same at the storage location, for example on the transport vehicle.

As already mentioned, the automation of the removal operation can be supported by the predetermined bale path and/or predetermined work plan. For example, the predetermined bale path and/or predetermined work plan can be used for a (partly) autonomously operating transport vehicle.

For example, the collection vehicle is designed as a partially or fully autonomous vehicle. The vehicle functions thereof can then be at least partly controlled automatically, by which means a higher level of automation of the removal operation is supported. The controller can be arranged inside and/or outside the collection vehicle. For example, suitable control means which can control individual vehicle functions of the collection vehicle, for example a steering function, driving function (e.g. driving strategy, driving speed, forward/reverse travel) or tool functions of the loading tool, are included in the collection vehicle. Optionally, these control means can also communicate with the transport vehicle in order additionally also to control vehicle functions, for example a steering function or driving function (e.g. driving strategy, driving speed, forward/reverse travel) of the transport vehicle. Alternatively, the aforementioned control means can be a constituent part of a central control station positioned inside or outside the harvest field. However, in the (partially) autonomous collection vehicle, a driver can be provided in the vehicle cab as a manual fall-back level.

The position path and/or the bale path and/or the work plan are for example predetermined as a function of at least one suitable parameter. Such parameters are represented, for example, by at least one of the following variables or features:
at least one bale-based feature of the bales (e.g. bale position, weight, size, shape, type);
at least one field-based feature of the harvest field (e.g. topography, area, outer limits);
at least one vehicle-based feature of the collection vehicle (e.g. number, position);
at least one tool-based feature of a loading tool of the collection vehicle (e.g. type of loading tool, bale holding capacity);
at least one vehicle-based feature of the transport vehicle (e.g. position, number, loading capacity for loading the bales, in the case of a plurality of vehicles, their order of arrival on the harvest field); and
at least one environment-based feature of the collection vehicle (e.g. objects on the harvest field such as bales or obstacles, a current position or status of the loading tool, specific arrangement of already stored bales at the storage location, other environmental features).

The aforementioned parameters and features are suitable to predetermine or to determine for example the shortest possible routes (bale path) to the bales and to the at least one transport vehicle, optimized for the collection vehicle. It is also possible for optimized, for example the shortest possible, routes (position path) for the transport vehicle to be predetermined. The position path can also be predetermined in such a way that, depending on the level of loading of the transport vehicle with bales, its storage position can be changed for the lowest possible ground compaction. The storage position of the transport vehicle can also be changed, for example, as a function of a current bale holding capacity of the collection vehicle, i.e. as a function of the number of bales that can be held simultaneously by the loading tool.

The aforementioned parameters and features can also be used to generate an efficient or optimized collection and loading strategy (work plan) for the at least one collection vehicle. In this case, the bale holding capacity of the collection vehicle and the current state of loading at the storage location, for example the transport vehicle, are for example taken into account. Since the detected parameters can change as the work plan is carried out, appropriate adaptation of the work plan during the performance of the collection and storage operation is also possible. In this way, the collection and loading of the bales can be adapted continuously as needed with the effect of an efficient working sequence.

In general, the transport path and/or the bale path and/or the work plan can be changed and/or adapted during the removal operation, in order to utilize potential efficiencies during the removal.

For example, at least one parameter or its values are represented by sensor signals from sensors arranged on the collection vehicle. In other words, various sensors attached to the collection vehicle (e.g. camera, lidar, radar, ultrasound) can provide the sensor data which is needed in order to support efficient and for example automated performance of the removal operation. The sensor data can, for example, support the generation of the work plan. Suitable sensor data can also permit an automated collection and storage operation for the collection vehicle and for example contribute to implementing a fully autonomous collection vehicle.

To carry out the method, a system having suitable control means is for example provided. These control means process different data and can control functions of the at least one collection vehicle and/or of the at least one transport vehicle on the basis of the data processing. This control can relate, for example, to a driving function (e.g. steering, driving speed, forward/reverse travel) of the collection vehicle and/or the transport vehicle. The control can also relate to the movement control of a loading tool of the collection vehicle, the collection of bales and their loading at the storage location being carried out by means of the loading tool.

The aforementioned control means support automated performance of the method and, consequently, also more efficient movement (collection, loading and storage at the storage location) of the bales. The automation also permits more efficient use of partly or fully autonomous collection vehicles and/or transport vehicles.

The control means for example comprise at least one suitable control unit. For example, the at least one control unit is arranged completely in the collection vehicle. In this variant, control of the functions of the transport vehicle or the transport fleet is for example carried out via a wire-free radio connection between the collection vehicle and the transport vehicle or vehicles to be controlled. Alternatively, the at least one control unit is at least partly arranged outside the collection vehicle, for example in a central control station. The central control station can be located inside or outside the harvest field.

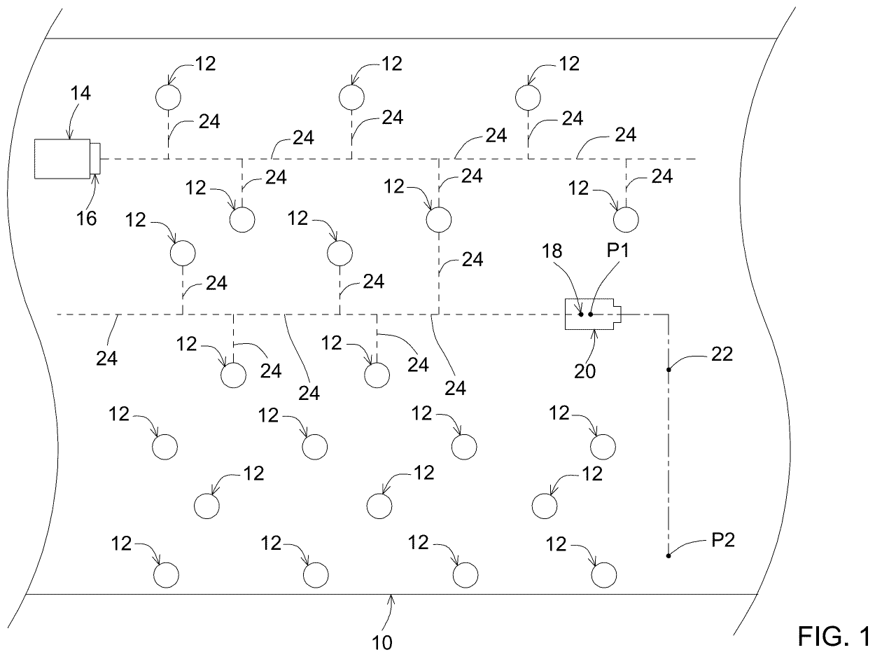

FIG. 1 shows, schematically and as a detail, a harvest field 10 having a large number of bales 12, which are collected by a collection vehicle 14 having a loading tool 16 and are transported to a storage location 18. This operation is repeated many times if necessary, depending on the number of bales 12 to be removed and the loading capacity of the collection vehicle 14. The bales 12 are thereby stored at the storage location 18. In an example embodiment, a transport vehicle 20, onto which the bales 12 are loaded by means of the collection vehicle 14, is located at the storage location 18.

For the removal operation comprising the collection and storage of the bales 12 at the storage location 18, a plurality of collection vehicles 14 and/or a plurality of transport vehicles 20 can optionally also be used. The vehicles 14, 20 can be controlled manually by drivers. Alternatively, individual vehicles (e.g. the at least one collection vehicle 14) or all the vehicles 14, 20 can be (partly) autonomous and at least partly controlled automatically. In this case, it is possible to dispense completely with drivers in the vehicles 14, 20, or the drivers are located in the vehicles 14, 20 as a manual full-back level.

A mobile storage location 18 for the bales 12 is implemented by means of the at least one transport vehicle 20. During the removal operation, the position of the storage location 18 can therefore be changed as needed. For example, starting from a storage position P1, the storage location 18 is given a changed storage position P2 during the removal operation.

The storage location 18, for example the transport vehicle 20, is transferred to the new storage position P2 along a predetermined position path 22. In this way, for example, routes of the collection vehicle 14 to the storage location 18 can be reduced further during the removal operation. Undesired soil compaction by the transport vehicle 20 can likewise be reduced, by the transport vehicle 20 already being moved to the new storage position P2, for example in an edge area of the harvest field 10, starting from a specific level of loading with bales 12.

A bale path 24 is predetermined for the routes of the collection vehicle 14. Thus, the collection vehicle 14 receives defined routes for approaching the bales 12 and for transporting the collected bales 12 to the storage location 18. The bale path 24 can be determined or predetermined as a function of specific criteria (e.g. minimizing an overall route of the collection vehicle 14 on the harvest field 10).

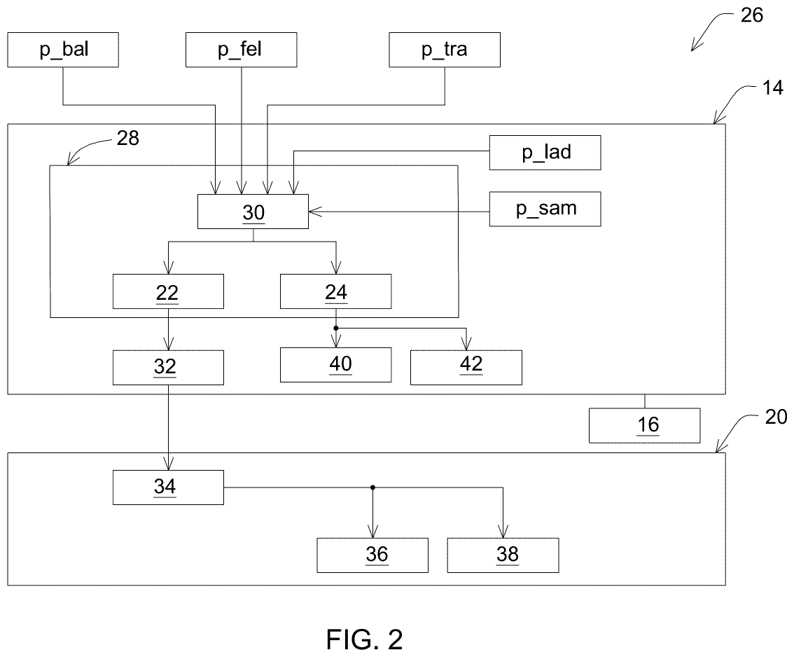

FIG. 2 shows a system 26 for carrying out the removal operation. The system includes at least one collection vehicle 14, at least one transport vehicle 20 and control means. In the embodiment according to FIG. 2, the control means have a control unit 28 (e.g., a controller including a processor and memory), which is arranged in the collection vehicle 14. An optimization algorithm 30 contained in the control unit 28 determines the transport path 22 and the bale path 24. The predetermination of the transport path 22 and of the bale path 24 by the optimization algorithm 30 is carried out as a function of input data for the control unit 28.

This input data can, for example, be generated by suitable sensors and/or be available as provided information. It represents, for example, the following parameters and features:
at least one bale-based feature p_bal of the bales 12 (e.g. bale position, weight, size, shape, type);
at least one field-based feature p_fel of the harvest field 10 (e.g. topography, area, outer limits);
at least one vehicle-based feature p_sam of the collection vehicle 14 (e.g. number, position);
at least one tool-based feature p_lad of the loading tool 16 of the collection vehicle 14 (e.g. type of loading tool 16, bale holding capacity); and/or
at least one vehicle-based feature p_tra of the transport vehicle 20 (e.g. position, number, loading capacity for loading the bales 12, in the case of a plurality of transport vehicles 20, the order of their arrival on the harvest field 10).

Further parameters and features not disclosed here can likewise be provided as input data for the optimization algorithm 30.

The control unit 28 transmits the data from the predetermined transport path 22 to a transmitter unit 32, which is for example arranged in the collection vehicle 14. The transmitter unit 32 communicates with a receiver unit 34, which is for example integrated into the transport vehicle 20. The data received by the receiver unit 34 can be used as control data in order to control individual vehicle functions of the transport vehicle 20, for example a steering unit 36 and a driving strategy unit 38 (e.g. driving strategy, driving speed, forward/reverse travel). In this way, the routes of the transport vehicle 20 during the removal operation can be automated. Alternatively, the data received by the receiver unit 34 can be reproduced acoustically and/or visually in the transport vehicle 20 by suitable means (e.g. a monitor unit or navigation system), in order that a driver can control the transport vehicle 20 according to the predetermined transport path 22.

Furthermore, the control unit 28 is used to control individual vehicle functions of the collection vehicle 14 with the aid of the control data corresponding to the predetermined bale path 24, for example a steering function unit 40 and a driving function unit 42 (e.g. driving strategy, driving speed, forward/reverse travel). In this way, the routes of the collection vehicle 14 during the removal operation can be automated. Alternatively, the data from the bale path 24 can be reproduced acoustically and/or visually in the collection vehicle 14 by suitable means (e.g. a monitor unit or navigation system), in order that a driver can control the collection vehicle 14 according to the predetermined bale path 24.

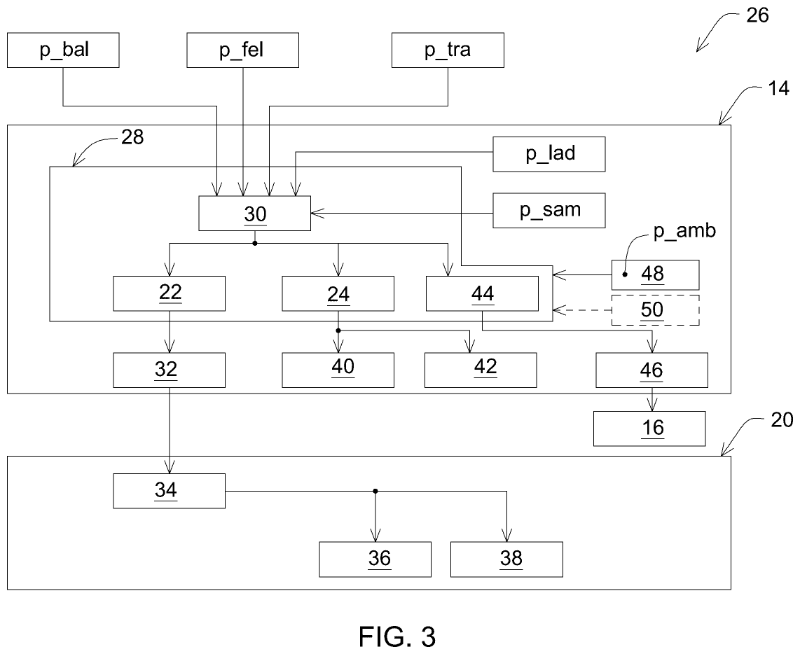

FIG. 3 shows a further embodiment of the system 26. In this embodiment, the optimization algorithm 30 additionally determines a work plan 44 besides the transport path 22 and the bale path 24. The control unit 28 controls a tool function of the loading tool 16 on the basis of the predetermined work plan 44. Here, a loading control unit 46 integrated into the collection vehicle 14 is provided to control the movement and working sequences of the loading tool 16. The predetermined work plan thus permits automated collection and loading of the bales 12 without any activities of a driver in the collection vehicle 14.

The work plan 44 can be predetermined as a function of at least one of the aforementioned parameters. In addition, the work plan 44 is also determined or predetermined as a function of at least one environment-based feature p_amb of the environment of the collection vehicle 14. The at least one environment-based feature p_amb of the collection vehicle 14 can be, for example, objects on the harvest field 10 such as bales 12 or obstacles, a current position or status of the loading tool 16, a specific arrangement of bales 12 already stored at the storage location 18 or on the transport vehicle 20 or other environmental features.

The at least one parameter or feature p_amb is represented by sensor signals or sensor data from sensors 48 arranged on the collection vehicle 14 and/or on its loading tool 16. The sensor signals or sensor data are transmitted to the control unit 28 and taken into account by the latter when determining the work plan 44.

The necessary technical equipment of the sensors 48 (e.g. camera, lidar, radar, ultrasound) depends on the desired level of automation of the removal operation. For automated collection and loading of the bales 12, generally fewer sensor components are needed than for a fully autonomous collection vehicle 14 which, in addition to the automated collection and loading of the bales 12, also carries out all the further functions during the removal operation independently and automatically, i.e. without a driver.

In the fully autonomous variant of the collection vehicle 14, in addition to the sensors 48, there may if necessary also be one (or more) additional system(s) 50, the data from which is sent to the control unit 28.

The terminology used herein is for the purpose of describing example embodiments or implementations and is not intended to be limiting of the disclosure. As used herein, the singular forms “a,” “an,” and “the” are intended to include the plural forms as well, unless the context clearly indicates otherwise. It will be further understood that the use of the terms “has,” “includes,” “comprises,” or the like, in this specification, identifies the presence of stated features, integers, steps, operations, elements, and/or components, but does not preclude the presence or addition of one or more other features, integers, steps, operations, elements, components, and/or groups thereof.

Those having ordinary skill in the art will recognize that terms such as “above,” “below,” “upward,” “downward,” “top,” “bottom,” etc., are used descriptively for the drawings, and do not represent limitations on the scope of the present disclosure, as defined by the appended claims. Furthermore, the teachings may be described herein in terms of functional and/or logical block components or various processing steps, which may include any number of hardware, software, and/or firmware components configured to perform the specified functions.

Terms of degree, such as “generally,” “substantially,” or “approximately” are understood by those having ordinary skill in the art to refer to reasonable ranges outside of a given value or orientation, for example, general tolerances or positional relationships associated with manufacturing, assembly, and use of the described embodiments or implementations.

As used herein, “e.g.,” is utilized to non-exhaustively list examples and carries the same meaning as alternative illustrative phrases such as “including,” “including, but not limited to,” and “including without limitation.” Unless otherwise limited or modified, lists with elements that are separated by conjunctive terms (e.g., “and”) and that are also preceded by the phrase “one or more of” or “at least one of” indicate configurations or arrangements that potentially include individual elements of the list, or any combination thereof. For example, “at least one of A, B, and C” or “one or more of A, B, and C” indicates the possibilities of only A, only B, only C, or any combination of two or more of A, B, and C (e.g., A and B; B and C; A and C; or A, B, and C).

While the above describes example embodiments or implementations of the present disclosure, these descriptions should not be viewed in a restrictive or limiting sense. Rather, there are several variations and modifications which may be made without departing from the scope of the appended claims.

What is claimed is:

1. A method for moving a plurality of bales which, during a removal operation on a harvest field, are collected via at least one collection vehicle and stored at a storage location inside or outside the harvest field, comprising:
determining via a control unit a storage position of the storage location as a function of a plurality bale positions of the plurality of bales in the harvest field; and
varying via the control unit the storage position of the storage location during the removal operation.

2. The of claim 1, wherein the storage location includes at least one transport vehicle for the removal of the plurality of bales.

3. The method of claim 1, wherein the storage location includes a transport fleet comprising at least two transport vehicles.

4. The method of claim 1, wherein a position path for changing the position of the storage location is determined via the control unit for the storage location.

5. The method of claim 4, wherein a vehicle function of the transport vehicle is controlled as a function of the position path.

6. The method of claim 5, wherein the transport vehicle is designed to be controlled as an autonomous vehicle.

7. The method of claim 5, wherein a bale path for approaching plurality of bales and for transporting the plurality of bales to the storage location is predetermined for the collection vehicle.

8. The method of claim 7, wherein a work plan for collecting the plurality of bales and storing the plurality of bales at the storage location is predetermined for the collection vehicle.

9. The method of claim 8, wherein a vehicle function of the collection vehicle is controlled as a function of the predetermined bale path and the predetermined work plan.

10. The method of claim 9, wherein a tool function of a loading tool, which is arranged to collect and load the plurality of bales on the collection vehicle, is controlled as a function of the predetermined work plan.

11. The method of claim 10, wherein the collection vehicle is designed to be controlled as an autonomous vehicle.

12. The method of claim 8, wherein the position path, the bale path, and the work plan are predetermined as a function of at least one of the following parameters:
at least one bale-based feature of the plurality of bales,
at least one field-based feature of the harvest field,
at least one vehicle-based feature of the collection vehicle,
at least one tool-based feature of a loading tool of the collection vehicle,
at least one vehicle-based feature of the transport vehicle, and
at least one environment-based feature of the environment of the collection vehicle.

13. The method of claim 12, wherein at least one of the parameters is represented via sensor signals from sensors arranged on the collection vehicle.

14. A system for moving a plurality of bales which, during a removal operation on a harvest field, are collected via at least one collection vehicle and stored at a storage location inside or outside the harvest field, comprising:
a control unit configured to determine a storage position of the storage location as a function of a plurality of bale positions of the plurality of bales in the harvest field, and vary the storage position of the storage location during the removal operation.

15. The system of claim 14, wherein the control unit is configured to determine a position path for changing the position of the storage location.

16. The system of claim 15, wherein the control unit is configured to predetermine a bale path for approaching and transporting the plurality of bales to the storage location for the collection vehicle.

17. The system of claim 16, wherein the control unit is configured to predetermine a work plan for collecting the plurality of bales and storing the plurality of bales at the storage location for the collection vehicle.

18. The system of claim 17, wherein the control unit is configured to control a tool function of a loading tool, which is arranged to collect and load the plurality of bales on the collection vehicle, as a function of the predetermined work plan.

19. The system of claim 18, wherein the control unit is configured to predetermine the position path, the bale path, and the work plan as a function of at least one of the following parameters:
at least one bale-based feature of the plurality of bales,
at least one field-based feature of the harvest field,
at least one vehicle-based feature of the collection vehicle,
at least one tool-based feature of a loading tool of the collection vehicle,
at least one vehicle-based feature of the transport vehicle, and
at least one environment-based feature of the environment of the collection vehicle.

20. The system of claim 19, further comprising at least one sensor arranged on the collection vehicle providing sensor signals representing at least one of the parameters.
